(19) United States
(12) Patent Application Publication
(10) Pub. No.: US 2012/0301659 A1
(43) Pub. Date: Nov. 29, 2012

(54) BIO-BASED TERPOLYMERS AND PROCESS OF MAKING THE SAME

(75) Inventor: Sundar Mohan Rao, Chattanooga, TN (US)

(73) Assignee: INVISTA North America S.a r.I., Wilmington, DE (US)

(21) Appl. No.: 13/576,256

(22) PCT Filed: Jan. 31, 2011
(86) PCT No.: PCT/US2011/023147

§ 371 Date: Jul. 31, 2012

Related U.S. Application Data
(60) Provisional application No. 61/300,308, filed on Feb. 1, 2010.

(51) Int. Cl. C08G 63/685; B32B 33/00; C08G 63/78; C08L 67/00; C08K 3/22

(52) U.S. Cl. 428/97; 528/339; 528/338; 525/420; 525/425; 524/607; 428/221

(57) ABSTRACT

Polyamide terpolymer compositions, which contain biobased monomers and are suitable for making shaped articles, are disclosed. Comprised of three monomeric species polymerized randomly, including hexamethylene diamine, adipic acid and a bio-based monomer, the compositions are easier to process and have better dye uniformity than polyamides formed from melt-blended biobased components, and are comparable in dyeability, color fastnessand appearance retention performance to non-biobased polyamide copolymers.

### RELATED APPLICATIONS

This application claims priority to U.S. Provisional Application No. 61/600,308, which is herein incorporated by reference in its entirety.

### FIELD OF THE INVENTION

The invention of this disclosure relates to polyamides comprised of three monomeric species, including hexamethylene diamine, adipic acid and a bio-based monomer constituent, the composition being suitable for making shaped articles. Compositions and the process of making the polyamides suitable for the manufacture of carpet fiber are also disclosed.

### BACKGROUND OF THE TECHNOLOGY

The makeup of useful fibrous materials has long been based purely on naturally available fibers such as wool and cotton. The past century, however, has seen the rapid rise of petrochemical fibers for good technical and economic reasons. As an example, the flooring industry has widely replaced short length natural fibers with continuous filaments composed of petrochemical polymers such as nylon, polyester and even polypropylene, because filament processes are cheaper to run, continuous filaments require less processing prior to being tufted, and deep pile continuous filament carpets are not subject to the shedding observed in deep pile carpets composed of short filaments.

Until now, bio-based materials have been introduced for the commercial manufacture of fibers, including carpet fibers made from propanediol derived from corn sugar and terephthalic acid, similar to normal polyester. Such polytrimethyleneterephthalate (PPT) fibers have enjoyed a measure of market success for their high biobased content. Unfortunately, however, in addition to being derived from food-quality intermediates, PTT fiber is also much less durable than nylon, which is especially important in flooring applications, and it is strongly oleophilic, which is also somewhat undesirable.

Another common biobased fiber, Polylacticacid (PLA) fiber, or polylactide fiber, is approximately 85% derived from sugar, a biobased intermediate. However, PLA fiber is not durable enough for many applications, especially where crush and abrasion resistance are important.

As an alternative to the polymers cited above, it has recently been recognized that melt blending petrochemical nylon polymer with biobased polymers can add bio-based content to the polymer while maintaining many of the more desirable properties of nylon, especially at lower addition levels. Unfortunately, the processes and equipment required to make such melt blended polymers add cost. Further, compatible bio-based polymers that can be successfully melt-blended into nylon are relatively expensive. In addition, both melt uniformity and dye uniformity can be difficult to maintain with such mixtures, making them somewhat less suitable for dye critical applications. As a result, commercialization of such fibers made from melt blended biobased polymers is somewhat limited.

Nylon co-polymers have long been investigated for their potential benefits. U.S. Pat. Nos. 5,242,733 and 5,399,306 disclose minor component additions having been made through melt blending to improve properties such as stain resistance and to impede crystalline formation in the quench for improved productivity. U.S. Pat. No. 5,223,196 discloses that minor concentrations of hindered amines and even polycaprolactam could also inhibit crystalline or spherelitic structure formations in the filament quenching process when introduced randomly into the monomer salt mixtures prior to polymerization. Such random additions, however, can lead to an unacceptable degradation of nylon polymer properties.

### SUMMARY OF THE INVENTION

While petrochemical fibers are widely understood to be useful, there is broad interest in conserving petrochemicals in general, and replacement with easily replaceable, or sustainable, biological materials is generally perceived as desirable. Further, random melt blending of bio-based polymers, hindered amines, and polycaprolactam leads to unacceptable degradation of nylon polymer properties.

Therefore, it would be desirable to find a durable polymer comprised of bio-based intermediates, if the source of the bio-based material would not be in direct competition for use in other resources. It is also essential that the resulting polymer be competitive in cost, and not compromise the performance value of the final product in any significant way.

It has been discovered and is hereby disclosed that, in contrast to amphoteric materials such as caprolactam, dibasic acids, such as sebacic acid, tend to have desirable properties if the polymerization process is extended sufficiently to obtain higher molecular weights and higher intrinsic viscosities than those alluded to in the prior art.

Disclosed herein is an economical process to obtain biobased, random terpolymers made from polyamides, such as Nylon, or polyesters, and biobased random co-monomers. The process comprises making random, biobased terpolymers by introducing bio-based co-monomers in the pre-polymerization stage of Nylon or polyester. For example, a Nylon 6,6/Nylon 6,10 biobased terpolymer is made from sebacic acid as a co-monomer along with hexamethylenediamine (“HMD”) and adipic acid as other monomers, by polymerizing in an autoclave or continuous polymerizer. This process results in a high viscosity, random terpolymer with biobased content and foregoes the need to melt blend the Nylon 6,6 with biobased polymer additives. Also provided are fibers and molded articles made from the random, biobased terpolymers. The fibers exhibit improved drawability and spinning characteristics. Further provided are acid dyeable random, biobased terpolymers and fiber, cat dyeable random, biobased terpolymers and fiber, and pigmented random, biobased terpolymers and fiber. The fibers can be of various deniers and cross sections for use in rugs, carpets, fabrics, industrial applications, automotive applications, and apparel.

In one aspect, a random, high viscosity terpolymer is provided. The terpolymer comprises the condensation polymer of three component intermediates comprising: (a) a first constituent unit comprising hexamethylene diamine, (b) a second constituent unit comprising adipic acid, and (c) a third constituent unit comprising at least one diacid selected from the group consisting of: Azelaic acid, sebacic acid, and 11-carboxyl-undecanoic acid (C11 aliphatic dicarboxylic acid). The weight percentage of the sum of the first and second constituent units is from about 55% to about 99.5%, including from about 65% to about 85%, and from about 90% to about 98%, and about 94.5%. The weight percentage of the third constituent unit is from about 0.5% to about 45%, including from about 2% to about 25%, and from about 1.5% to about 5%, including about 4.5%. The instrinsic viscosity of the terpolyer is greater than about 2.7 IV (in sulfuric acid), and the number average molecular weight is greater than about 10,000 grams per mole, including about 10,350. The random terpolymers can also comprise a melt blended additive, including virgin thermoplastic, recycled thermoplastic, polyethylene terephthalate, colorants, titanium dioxide, anti-microbial agents, stabilizers, flame retardants, and anti-oxidants. Further, the adipic acid in the second constituent unit can be replaced by terephthalic acid and mono ethylene glycol. A portion of the adipic acid in the second constituent unit can be replaced by lsophthalic aicd, 5-sulfoisophthalic acid, or terepthalic acid. A portion of the first constituent, hexamethylene diamine, can be replaced by Methylpentamethylene diamine. These additional acids and diamines are present at a weight percentage of 0.1% to 10% by weight of the terpolymer.

The terpolymers can be manufactured into molded articles, including fibers or pellets. Also, the molded articles can also comprise melt blended additives, including virgin thermoplastic, recycled thermoplastic, polyethylene terephthalate, colorants, titanium dioxide, anti-microbial agents, stabilizers, flame retardants, and anti-oxidants.

In another aspect, a fiber comprising random, high viscosity terpolymers is provided. The terpolymers comprise the condensation polymer of three component intermediates comprising: (a) a first constituent unit comprising hexamethylene diamine, (b) a second constituent unit comprising adipic acid, and (c) a third constituent unit comprising at least one diacid selected from the group consisting of: Azelaic acid, sebacic acid, and 11-carboxyl-undecanoic acid (C11 aliphatic dicarboxylic acid). The weight percentage of the sum of the first and second constituent units is from about 55% to about 99.5%, including from about 65% to about 85%, and from about 90% to about 98%, and about 94.5%. The weight percentage of the third constituent unit is from about 0.5% to about 45%, including from about 2% to about 25%, and from about 1.5% to about 5%, including about 4.5%. The instrinsic viscosity of the terpolymer is greater than about 2.7 IV (in sulfuric acid), and the number average molecular weight is greater than about 10,000 grams per mole, including about 10,350. The fiber can further comprise an additional component, including virgin thermoplastic, recycled thermoplastic, polyethylene terephthalate, colorants, titanium dioxide, anti-microbial agents, stabilizers, flame retardants, and anti-oxidants. Carpets, rugs, and fabrics can be made from the fiber. Further, the adipic acid in the second constituent unit can be replaced by terephthalic acid and mono ethylene glycol. A portion of the adipic acid in the second constituent unit can be replaced by Isophthalic aicd, 5-sulfoisophthalic acid, or terepthalic acid. A portion of the first constituent, hexamethylene diamine, can be replaced by Methylpentamethylene diamine. These additional acids and diamines are present at a weight percentage of from about 0.1% to about 10% by weight of the terpolymer.

In a further aspect, a process for making a random, high viscosity terpolymer is disclosed. The process comprises: (a) providing a blend of first and second co-monomer salts to a first reactor, wherein the first co-monomer salt comprises hexamethylene diamine and a diacid component selected from azelaic acid, sebacic acid, and 11-carboxyl-undecanoic acid (C11 aliphatic dicarboxylic acid), and the second co-monomer salt comprises adipic acid and hexamethylene diamine; (b) copolymerizing said blended salts, wherein said copolymerizing occurs in a second reactor; and (c) conditioning the resulting polymer to achieve an IV (in sulfuric acid) of greater than 2.7.

The conditioning can be done at a temperature of about 180° C. for about 10 hours. The concentration of diacid can be maintained at a weight percentage of from about 0.5% to about 45%, including from about 2% to about 25%, and from about 1.5% to about 5%, including about 4.5%, of the polymer. Also, the polyamide co-monomer salt can be replaced by terephthalic acid and mono ethylene glycol, which results in a random, high viscosity terpolymer with polyester constituent units and biobased polyamide constituent units. A portion of the adipic acid can be replaced by lsophthalic aicd, 5-sulfoisophthalic acid, or terepthalic acid. A portion of the hexamethylene diamine can be replaced by Methylpentamethylene diamine. These additional acids and diamines are present at a weight percentage of from about 0.1% to about 10% by weight of the polymer.

### DETAILED DESCRIPTION OF THE INVENTION

A random, high viscosity terpolymer containing biobased constituent units is disclosed. The terpolymer comprises a first constituent unit comprising hexamethyldiamine (“HMD”), a second constituent unit comprising adipic acid, and a third constituent unit comprising at least one diacid selected from the group consisting of Azelaic acid, sebacic acid, and 11-carboxyl-undecanoic acid (C11 aliphatic dicarboxylic acid). The sum of the first and second constituent units is present at a weight percentage from about 55% to about 99.5%, including from about 65% to about 85%, and from about 90% to about 98%, and about 94.5%, of the terpolymer. The third constituent unit is present at a weight percentage from about 0.5% to about 45%, including from about 2% to about 25%, and from about 1.5% to about 5%, including about 4.5%, of the terpolymer. The intrinsic viscosity of the terpolymer is greater than about 2.7 IV (in sulfuric acid) and the number average molecular weight is greater than about 10,000 grams per mole, including about 10,350 grams per mole. The terpolymer is truly random without large repeating blocks of constituent units typically found in non-randomized block co-polymers.

The adipic acid in the second constituent unit can be replaced with terephthalic acid and mono ethylene glycol. This results in a random, high viscosity terpolymer with polyester constituent units and biobased polyamide constituent units. When the diacid is sebacic acid, the concentration of the third constituent unit is from about 1.5% to about 5%, including about 4.5% of the weight of the terpolymer. A portion of the adipic acid in the second constituent unit can be replaced by Isophthalic aicd, 5-sulfoisophthalic acid, or terepthalic acid. A portion of the first constituent, hexamethylene diamine, can be replaced by Methylpentamethylene diamine. These additional acids and diamines are present at a weight percentage of from about 0.1% to about 10% by weight of the terpolymer.

Additionally, the random terpolymer can comprise a melt blended additive. The additive can include virgin thermoplastic, recycled thermoplastic, polyethylene terephthalate, colorants, titanium dioxide, anti-microbial agents, stabilizers, flame retardants, and anti-oxidants. Also, acid dyes, cationic dyes, and pigments can be added to the terpolymer. The thermoplastics can include biobased polymers, polyamides, polyethylenes, polypropylenes, polyesters, polyolefins, and recycled carpet fiber.

Molded articles can be made from the random, high viscosity terpolymers. The molded articles can include fibers, pellets, and other shaped articles. The molded articles can include an additional component, including virgin thermoplastic, recycled thermoplastic, polyethylene terephthalate, colorants, titanium dioxide, anti-microbial agents, stabilizers, flame retardants, and anti-oxidants. The molded articles can also include acid dyes, cationic dyes, and pigments.

Fibers made from the random, high viscosity terpolymers can be manufactured in deniers ranging from about 50 to about 4000, including from about 600 to about 1000, and from about 920 to about 1120. The fibers can also be drawn from about 1.0 to about 3.0, including from about 2.5 to about 2.75, and 2.6. The fibers can have a percent draw before hot chest from about 80% to about 95%, including about 90%. That is, the fiber from the spinneret goes to a feed roll and is drawn prior to entering the hot chest, where it is heated to a temperature sufficient to provide bulking in the bulking chest. The fibers can be mixed with various additives, including virgin thermoplastic, recycled thermoplastic, polyethylene terephthalate, colorants, titanium dioxide, anti-microbial agents, stabilizers, flame retardants, and anti-oxidants. Further, the fibers can be acid, cat, or pigmented died. The fibers can be manufactured into carpets, rugs, or fabrics.

A process for making random, high viscosity terpolymers by introducing bio-based co-monomers in the pre-polymerization stage is disclosed. The process comprises copolymerizing biobased comonomers, such as sebacic acid made from Castor oil, with polyamide comonomers, such as HMD and adipic acid. For example, the process can comprise (a) providing a blend of first and second co-monomer salts to a first reactor, wherein the first co-monomer salt comprises hexamethylene diamine and a diacid component selected from azelaic acid, sebacic acid, and 11-carboxyl-undecanoic acid (C11 aliphatic dicarboxylic acid), and the second co-monomer salt comprises adipic acid and hexamethylene diamine; (b) copolymerizing said blended salts, wherein said copolymerizing occurs in a second reactor; and (c) conditioning the resulting polymer to achieve an IV (in sulfuric acid) of greater than 2.7. A portion of the adipic acid can be replaced by Isophthalic aicd, 5-sulfoisophthalic acid, or terepthalic acid and a portion of the hexamethylene diamine can be replaced by Methylpentamethylene diamine. These additional acids and diamines are present at a weight percentage of from about 0.1% to about 10% by weight of the polymer.

The intrinsic viscosity of the resulting terpolymer is greater than about 2.7 and the number average molecular weight greater than about 10,000 grams per mole, including about 10,350. The melting temperature of the terpolymer is from about 210° C. to about 285° C., including 240° C. to about 260° C., and about 250° C.

When the diacid is sebacic acid, the biobased co-monomer salt can be prepared as a 30%-45% aqueous salt solution, including about 30%, at a concentration of about 63.5 weight percent (dry basis) sebacic acid and 36.5 weight percent (dry basis) hexamethylenediamine in de-ionized water. The reaction of the amine with the diacid is exothermic, however, additional heat can be used to dissolve the acid. The final batch temperature is around 40° C. once a clear homogeneous solution is obtained.

In one method of making a Nylon 6,6/Nylon 6,10 random, high viscosity terpolymer, the 30% concentration of sebacic co-monomer salt from above is added to an evaporator containing Nylon 6,6 salt (hexamethylenediamine and adipic acid) and excess hexamethylenediamine. The sebacic acid concentration was maintained at about 4.5% by weight of the polymer. Evaporation was done with 300 psi steam for about 23 minutes. The final salt concentration in the evaporator was approximately 83%. The concentrated salt from the evaporator was transferred to an autoclave, wherein water was further evaporated from the salt mixture with increasing pressure and temperature. After cooking for about 90 minutes, pressure was released and the final polymer temperature was about 269° C. The polymer was extruded into strands, which were quenched in water and cut into pellets. The resulting polymer had a relative viscosity of 35 RV and a number average molecular weight of approximately 10,350 grams per mole as determined by Gel permeation chromatography. The polymer flake was then dried and conditioned. High molecular weight was achieved by conditioning under dry nitrogen at about 180° C. for about 10 hours. This polymer was melt extruded through a twin screw extruder and spun into BCF yarn fiber. The resulting fiber was determined to have a relative viscosity of 68 RV.

In one aspect, Nylon 6,6/Nylon 6,10 random, high viscosity terpolymer, having 4.5% by weight sebacic acid content, was spun into a 1127 denier fiber with a mixed MR cross section and 0.15% titanium dioxide, and drawn to a ratio of 2.6. This fiber had a more open structure and increased draw percentage than a Nylon 6,6 copolymer containing 2.5% by weight of a 1:1 mole ratio blend of isophthalic acid and methyl pentamethylene diamine, which resulted in comparable MBB dyeability and nitrous oxide and ozone degradation. The increase in draw percentage resulted in improved spinning robustness. Additionally, the Nylon 6,6/Nylon 6,10 random, high viscosity terpolymer fiber could be drawn to a ratio of 2.75, with only a slight change in MBB dyeability. This small change in MBB dyeability with a significant change in draw ratio is a beneficial surprise, since one would expect a much higher MBB dyeability with this high draw ratio.

### EXAMPLES

The following are examples of fibers made from prior art Nylon 6,6 copolymers and one aspect of the disclosed biobased copolymer.

### Test Methods

Melting Point is determined using a differential scanning calorimeter and reported in degrees Celsius.

MBB dyeability is determined by using skeined yarn dyed with Anthraquinone Milling Blue BL (MBB) dye and darkness/lightness is measured using spectrometer to provide the MBB dye value (as described in U.S. Pat. No. 4,719,060—hereby incorporated by reference in its entirety).

The change in color values represented by CIE Delta E is determined in the following manner:
a. The fiber was made into knit socks and heat set to 265° F. in a Superba heat setting machine.
b. After heat setting, the socks were dyed in a mixture of blue, red, and yellow acid dyes to get a medium gray color in an AHIBA dye bath.
c. The L, a, and b color values were determined using a Datacolor(R) spectra photometer.
d. CIE Delta E was determined by comparing the original L, a, b value with the L, a, b value after Nitrous Oxide and Ozone exposure.

Nitrous Oxide and Ozone tests are used in conjunction with the CIE Delta E measurement to determine a fabric's color fastness in the presence of nitrous oxide. The Nitrous Oxide test was conducted using the AATCC test procedure 164 for 2 cycles and 4 cycles and Ozone test was conducted using the AATCC test procedure 129 for 2 cycles and 4 cycles.

### Example 1

### (Comparative—Nylon 6,6 Copolymer)

The Nylon 6,6 copolymer was made using conventional polymerization techniques. The Nylon 6,6 copolymer contained 2.5% of a mixture (1:1 mole ratio) of isophthalic acid and methylpentamethylene diamine co-monomers. The copolymer was then spun using a twin screw extruder into 1127 denier fiber with a mixed MR cross section. The fiber also had 0.15% titanium dioxide and was drawn to a ratio of 2.6. The resulting fiber had a 74.9% draw before going into a hot roll chest.

### Example 2

### (Nylon 6,6/Nylon 6,10 Random Terpolymer)

The Nylon 6,6/Nylon 6,10 random, high viscosity terpolymer contained sebacic acid in a weight percentage of 4.5% by weight of terpolymer and was made as described above in paragraphs 0025 and 0026. The terpolymer was then spun into fiber in the same manner as Example 1 above. The resulting fiber had a 92.7% draw before going into a hot roll chest, which resulted in improved spinning compared to the prior art Nylon 6,6 copolymer.

The properties of the copolymers and fibers are provided below in Table 1.

TABLE 1
Material Properties

| | | | | ΔE 4 | ΔE 2 | ΔE 4 |
|---|---|---|---|---|---|---|
| | Melting | | ΔE 2 cycle | cycle | cycle | cycle |
| | Point | MBB | NOX | NOX | Ozone | Ozone |
| Example 1 | 255.80° C. | 164 | 3.12 | 5.64 | 3.21 | 8.98 |
| Example 2 | 253.81° C. | 166 | 2.59 | 5.91 | 3.37 | 9.21 |

The increase in % draw of Example 2, surprisingly, did not increase the MBB. It should be noted that the draw ratio was the same for examples 1 and 2. One would expect that the MBB similarities between Examples 1 and 2 to correlate to similar draw percentages. Because the random, high viscosity terpolymer fiber has similar MBB, Nitrous Oxide color fastness, and Ozone color fastness but with increased drawability, the fiber is more processable in downstream spinning machines than the prior art Nylon 6,6 copolymer fiber.

The following measures the step color when Examples 1 and 2 are dyed with 1100 denier deep dyeing fiber. The fibers from Example 1 and 2 where spun into 1127 denier knit socks and where dyed together with 1100 denier deep dyeing fiber knit socks in a dye bath to medium gray color. The L, a, b color values of each knit socks after dyeing was measured and reported in Table 2 below, along with the CIE Delta E.

TABLE 2
Color Value

| 1127 Denier Knit Socks | | | | 1100 Denier Knit | | | |
|---|---|---|---|---|---|---|---|
| (Test Items) | | | | Socks (Control) | | | Comparison |
| | L | a | b | L | a | b | CIE |
| Medium Grey | Value | Value | Value | Value | Value | Value | ΔE |
| Example 1 | 65.11 | 1.39 | 0.82 | 56.23 | 1.64 | 0.88 | 8.88 |
| Example 2 | 65.21 | 1.55 | 0.64 | 56.75 | 1.75 | 0.85 | 8.46 |

The color values of dyed 1100 denier knit socks and 1127 denier knit socks of Examples 1 and 2 are very close (L, a, b). This suggests that the same step in dyeing is achieved with the fiber made from the random, high viscosity terpolymer as compared to the control fiber when competitively dyed together with deep dyeing 1100 denier fiber even though the test fiber had a more open structure as evidenced by lower melt point and more % draw for the same draw ratio. This is a surprising result.

The invention has been described above with reference to the various aspects of the disclosed random, high viscosity terpolymers, process and fibers made from the terpolymers. Obvious modifications and alterations will occur to others upon reading and understanding the proceeding detailed description. It is intended that the invention be construed as including all such modifications and alterations insofar as they come within the scope of the claims.

1. A random, high viscosity terpolymer comprising the condensation polymer of three component intermediates comprising:
a) a first constituent comprising hexamethylene diamine,
b) a second constituent unit comprising adipic acid, and
c) a third constituent unit comprising at least one diacid selected from the group consisting of: Azelaic acid, sebacic acid, and 11-carboxyl-undecanoic acid (C11 aliphatic dicarboxylic acid),
wherein the sum of the first and the second constituent units is present at a weight percentage from about 55% to about 99.5% of the terpolymer, and the third constituent is present at a weight percentage of about 0.5% to about 45% of the terpolymer; and further wherein the intrinsic viscosity of the terpolymer is greater than about 2.7 IV (in sulfuric acid) and the number average molecular weight is greater than about 10,000 grams per mole.

2. The random terpolymer of claim 1, wherein said third constituent unit is sebacic acid.

3. The random terpolymer of claim 1, wherein said first constituent unit further comprises methylpentamethylene diamine present at a weight percentage of from about 0.10% to about 10% of the terpolymer.

4. The random terpolymer of claim 1, wherein said second constituent unit further comprises an acid selected from the group consisting of isophthalic acid, 5-sulfoisophthalic acid, or terephthalic acid, wherein said acid is present at a weight percentage of from about 0.10% to about 10% of the terpolymer.

5. The random terpolymer of claim 2, wherein said third constituent unit is present at a weight percentage of about 4.5% of the terpolymer.

6. The random terpolymer of claim 1, further comprising a melt blended additive selected from the group consisting of: virgin thermoplastic, recycled thermoplastic, polyethylene terephthalate, colorants, titanium dioxide, anti-microbial agents, stabilizers, flame retardants, and anti-oxidants.

7. A molded article made from the random terpolymer of claim 1.

8. The molded article of claim 7 further comprising a component selected from the group consisting of: virgin thermoplastic, recycled thermoplastic, polyethylene terephthalate, colorants, titanium dioxide, anti-microbial agents, stabilizers, flame retardants, and anti-oxidants.

9. A fiber comprising a random, high viscosity terpolymer comprising the condensation polymer of three component intermediates comprising:
a) a first constituent unit comprising hexamethylene diamine
b) a second constituent unit comprising adipic acid, and
c) a third constituent unit comprising at least one diacid selected from the group consisting of: Azelaic acid, sebacic acid, and 11-carboxyl-undecanoic acid (C11 aliphatic dicarboxylic acid),
wherein the sum of the first and the second constituent units is present at a weight percentage from about 55% to about 99.5% of the terpolymer, and the third constituent is present at a weight percentage of about 0.5% to about 45% of the terpolymer; and further wherein the intrinsic viscosity of the terpolymer is greater than about 2.7 IV (in sulfuric acid) and the average number molecular weight is greater than about 10,000 grams per mole.

10. The fiber of claim 9, wherein said third constituent unit is sebacic acid.

11. The fiber of claim 9, wherein said first constituent unit further comprises methylpentamethylene diamine present at a weight percentage of from about 0.10% to about 10% of the terpolymer.

12. The fiber of claim 9, wherein said second constituent unit further comprises an acid selected from the group consisting of isophthalic acid, 5-sulfoisophthalic acid, or terephthalic acid, wherein said acid is present at a weight percentage of from about 0.10% to about 10% of the terpolymer.

13. The fiber of claim 10, wherein said third constituent unit is present at a weight percentage of about 4.5% of the terpolymer.

14. The fiber of claim 9, further comprising a component selected from the group consisting of: virgin thermoplastic, recycled thermoplastic, polyethylene terephthalate, colorants, titanium dioxide, anti-microbial agents, stabilizers, flame retardants, and anti-oxidants.

15. A carpet comprising the fiber of claim 9.

16. A fabric comprising the fiber of claim 9.

17. A process for making a random, high viscosity terpolymer comprising:
(a) providing a blend of first and second co-monomer salts to a first reactor, wherein the first co-monomer salt comprises hexamethylene diamine and a diacid component selected from azelaic acid, sebacic acid, and 11-carboxyl-undecanoic acid (C11 aliphatic dicarboxylic acid), and the second co-monomer salt comprises adipic acid and hexamethylene diamine; (b) copolymerizing said blended salts, wherein said copolymerizing occurs in a second reactor; and (c) conditioning the resulting polymer to achieve an IV (in sulfuric acid) of greater than 2.7.

18. The process of claim 17, wherein said first reactor is an evaporator.

19. The process of claim 18, wherein said second reactor is an autoclave.

20. The process of claim 17, wherein said diacid is maintained at a weight percentage of from about 0.5% to about 45% of the polymer.

21. The process of claim 17, wherein said diacid is sebacic acid.

22. The process of claim 21, wherein said sebacic acid is maintained at a weight percentage of about 4.5% of the polymer.

23. The process of one of claim 17, wherein said conditioning occurs at a temperature of about 180° C. for about 10 hours.

24. The process of claim 17, wherein a portion of the hexamethylene diamine is replaced by Methylpentamethylene diamine present at a weight percentage of from about 0.1% to about 10% by weight of the polymer.

25. The process of claim 17, wherein a portion of the adipic acid is replaced by an acid selected from the group consisting of isophthalic acid, 5-sulfoisophthalic acid, or terephthalic acid, wherein said acid is present at a weight percentage of from about 0.10% to about 10% of the polymer.
